(19) United States
(12) Patent Application Publication
(10) Pub. No.: US 2012/0223985 A1
(43) Pub. Date: Sep. 6, 2012

(54) INK-JET DEVICE

(75) Inventors: Sheng-fa Liu, Zhudong Township (TW); Ching-ho Li, Huatan Township (TW); Huai-an Li, Zhongli City (TW); Yu-hsien Chen, Kaohsiung City (TW)

(73) Assignee: CHUNGHWA PICTURE TUBES, LTD., Bade City (TW)

(21) Appl. No.: 13/174,774

(22) Filed: Jun. 30, 2011

(30) Foreign Application Priority Data
Mar. 4, 2011 (TW) 100203910

(51) Int. Cl. B41J 29/38

(52) U.S. Cl. 347/10

(57) ABSTRACT

Disclosed is an ink-jet device applicable to various ink-jet equipments. The device includes an ink reservoir, an ink chamber, pressure generating units and an ink-jet head. The ink-jet head has dielectric layers coated on an inner surface and an outer surface thereof. By applying a voltage to the dielectric layers, the dielectric layers are changed to be hydrophobic or hydrophilic, so as to reduce residual ink accumulated in the ink-jet head during the ink-jetting process, hence improving ink-jetting accuracy.

### BACKGROUND OF THE INVENTION

1. Field of the Invention

The present invention generally relates to an ink-jet device, and more particularly to an ink-jet device capable of changing an ink-jet head being hydrophilic or hydrophobic.

2. Description of Prior Art

With a flourishing electronic industry, the printing technology has developed and advanced rapidly from a previous dot-matrix impact printing technology to the recent ink-jet printing and laser printing technologies. In particular, the ink-jet printing technology utilizes an ink-jet head to jet-out tiny ink droplets onto specified areas of paper or equipment, and so the ink-jet printing technology can print-out predetermined pictures with selected colors. For the ink-jet printing, based on different operation principles, there are two major technologies: a thermal bubble printing technology and a piezoelectric printing technology. In the thermal bubble ink-jet printing, ink is instantaneously vaporized by a heater, and then high-pressure heated bubbles can generate kinetic energy to gather and push out the gasified ink through the ink-jet head. Although the thermal bubble ink-jet printing is often used, there are disadvantages of limiting heat dissipation and shorter life span. In the piezoelectric ink-jet printing, ink is jetted out through the ink-jet head by applying voltages to pressure generating units for generating compression pressure to deform the ink chamber, and thereby pushing out the ink through the ink-jet head. Although the piezoelectric ink-jet printing technology has advantages of longer life span and high speed printing over the others, there is a disadvantage of miniaturizing ink-jet devices using such.

Please refer to FIG. 1, which illustrates a piezoelectric ink-jet device 1. The piezoelectric ink-jet device 1 includes an ink chamber 10, an ink reservoir 20, pressure generating units 22, 24 (e.g. ceramic piezoelectric elements), and an ink-jet head 30. The ink chamber is utilized for temporarily storing ink to be used in the ink-jetting process and the ink is provided by the ink reservoir 20 through an ink supply channel 32.

Please refer to FIG. 2, which illustrates pressure generating units 22, 24, of the ink-jet device 1 being transformed. The pressure generating units 22, 24, are applied with voltages by a pulse generator 35 through a pair of first electrodes 26, 28 to compress the ink chamber 10, so that the ink stored in the ink chamber 10 is jetted-out through the ink-jet head 30. The ink-jet head 30 is used for narrowing an outflow channel thereby causing the ink in the ink chamber 10 to accurately jet-out onto a target object.

However, when the ink-jet head 30 is in an idle state for a long time period, an orifice of the ink-jet head 30 may accumulate residual ink, the ink contacts with atmosphere and therefore a solvent therein will be evaporated and the ink will become hardened. As a result, the orifice of the ink-jet head 30 will be blocked and clogged. To prevent the ink from being accumulated and hardened, a typical method is using a cap (not shown) to seal the orifice of the ink-jet head 30. However, even when the orifice of the ink-jet head is sealed, some ink can still become hardened thereby affecting the ink-jet head 30 to function properly.

In the current ink-jetting technology, residual ink can be easily accumulated and hardened in the ink-jet head after numerous times of ink-jetting, resulting in ink-jet volume and location to be less accurately controlled. Hence, reducing the residual ink accumulated in the ink-jet head 30 during the ink-jetting process can improve on accuracy of jetting-out ink, and accordingly improve the quality of ink-jet printing.

In addition, specific ink is purchased in accordance with the ink property of the ink-jet head 30 being hydrophilic or hydrophobic. A hydrophobic ink should be operated in coordination with a hydrophilic ink-jet head 30 and vice versa. Consequently, ink can be effortlessly jetted-out from the ink-jet head 30. Moreover, the ink is not easily accumulated and hardened in the ink-jet head 30 due to the difference between hydrophilic and hydrophobic. Therefore, if there is an alternative being available to simplify the matching manner between the ink-jet head and ink, it will be more convenient for a user in printing.

### SUMMARY OF THE INVENTION

The present invention provides an ink-jet device, which is capable of reducing residual ink accumulating in the ink-jet head during the ink-jetting process to improve ink-jetting accuracy. The present invention utilizes, but not limited to, a piezoelectric printing technology, as well as being applicable to various types of ink-jet printing technology.

To achieve the above-mentioned, the present invention ink-jet device comprises an ink chamber, an ink reservoir, pressure generating units and an ink-jet head.

In the ink-jet device of the present invention, the pressure generating units are coupled to a pulse generator through a pair of first electrodes. The pulse generator applies a voltage to cause the pressure generating units to compress and deform the ink chamber, so that the ink in the ink chamber is jetted out onto the target object through the ink-jet head.

In the ink-jet device of the present invention, the ink-jet head has dielectric layers coated on an inner surface and an outer surface thereof. The ink-jet head can be changed to be hydrophilic or hydrophobic by applying a voltage thereto. Thus residual ink accumulated and hardened in the ink-jet head after numerous ink-jetting is reduced, and clogging in the ink-jet head is also reduced. The ink-jetting accuracy is improved accordingly.

In the ink-jet device of the present invention, the ink-jet head has dielectric layers coated on its inner surface and outer surface, and said dielectric layers are made of materials selected from a group consisting of Teflon (known as PTFE, polytetrafluoroethylene), propylene, PVDF (polyvinylidene fluoride), HFP (hexafluoropene), a methyl group, and an ethyl group. The dielectric layers are changed to be hydrophilic or hydrophobic according to voltages applied by the voltage generating unit so as to reduce the residual ink accumulated and hardened in the ink-jet head.

In addition, the dielectric layers of the ink-jet head are changed to be hydrophilic or hydrophobic by controlling a voltage applied thereto so as to operate in coordination with the hydrophilic ink or hydrophobic ink. As a result, one ink-jet head is applicable for ink being hydrophilic or hydrophobic. Thus, a user can conveniently use the same ink-jet head and unnecessarily buy two different ink-jet heads to use different types of ink.

### BRIEF DESCRIPTION OF THE DRAWINGS

FIG. 1 is a schematic diagram illustrating a prior art ink-jet device before ink-jetting;

FIG. 2 is a schematic diagram illustrating the prior art ink-jet device during ink-jetting;

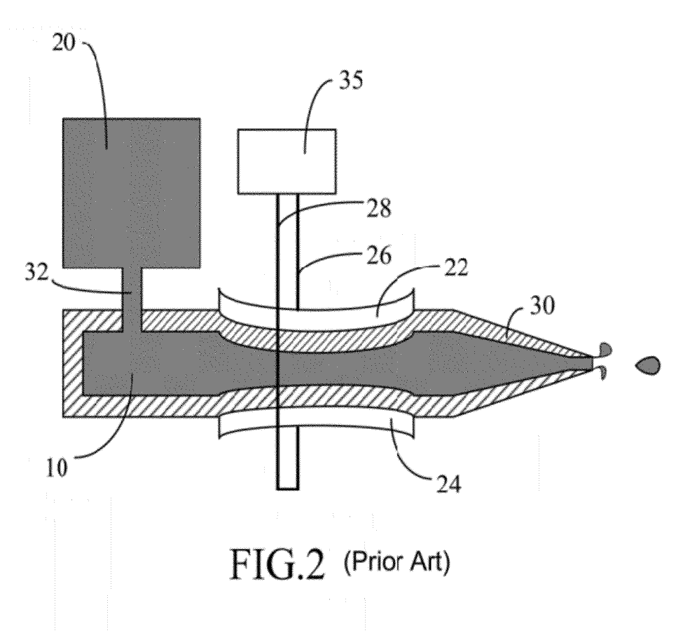

FIG. 3 is a schematic diagram illustrating an ink-jet device of the present invention before ink-jetting;

FIG. 4 is a schematic diagram illustrating the ink-jet device of the present invention during ink-jetting; and

FIGS. 5(a) to 5(c) are schematic diagrams illustrating an ink-jet head of the ink-jet device of the present invention before, during and after ink-jetting.

### DETAILED DESCRIPTION OF THE PREFERRED EMBODIMENTS

The present invention will be explained in details in conjunction with the accompanying drawings.

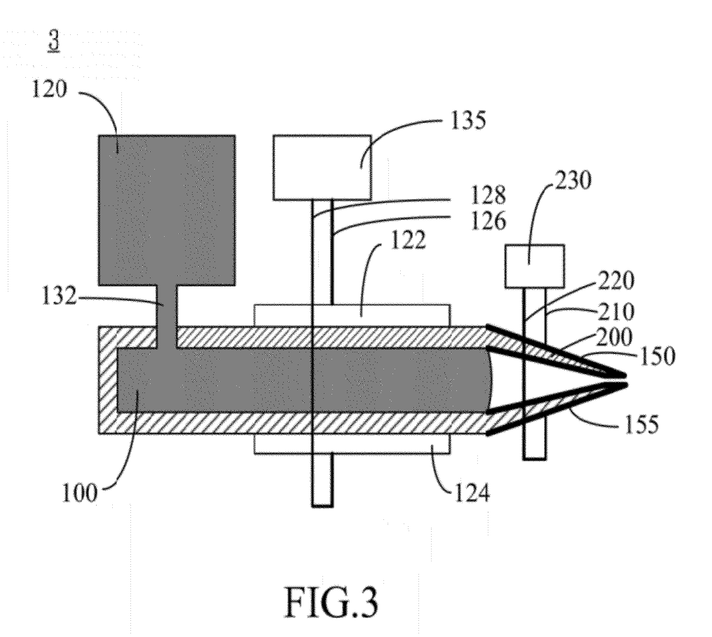

As shown in FIG. 3, which is a structural illustration of an ink-jet device 3 of the present invention. The ink-jet device 3 includes an ink-jet head 200, an ink chamber 100, pressure generating units 122, 124, and an ink reservoir 120.

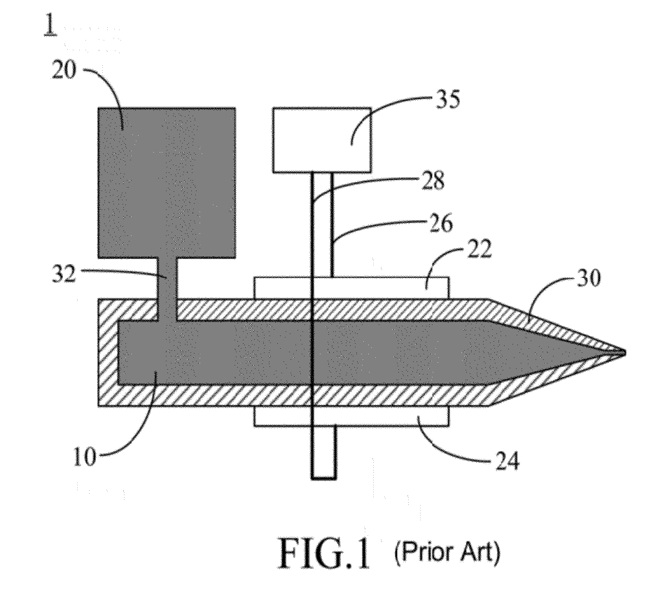

The ink chamber 100 is used for temporarily storing the ink required for an ink-jetting process. The pressure generating units 122, 124, are made of piezoelectric material such as ceramic piezoelectric or other suitable piezoelectric material. The pressure generating units 122, 124, are usually attached or connected onto the walls of the ink chamber 100. A pair of first electrodes 126, 128 are connected to the pressure generating units 122, 124, respectively. A pulse generator 135 is connected with the first electrodes 126, 128 and applies voltages to the first electrodes 126, 128. It is noted that the present invention is not limited to using the pulse generator 135. Any method that is capable of driving the pressure generating units 122, 124 is applicable for the present invention. As described above, the pulse generator 135 applies a voltage to the first electrodes 126, 128. According to the biasing direction of the voltage, a shear force is generated on the pressure generating units 122, 124 to deform the pressure generating units 122, 124. When the pressure generating units 122, 124 are deformed toward the ink chamber 100, the pressure makes the ink in the chamber 100 be jetted out through the ink-jet head 200. Moreover, the ink reservoir 120 is connected with the ink chamber 100 via an ink channel 132 to supply the ink to the ink chamber 100. The above structure is the same as the ink-jet device 1 shown in FIG. 1. Therefore, the detailed description is omitted herein to avoid reiteration.

As stated above, the residual ink can be easily accumulated in the ink-jet head 200 after ink is jetted out, thereby affecting the next ink-jetting process. In addition, the residual ink that is accumulated at the orifice of the ink-jet head 200 can become hardened, thereby affecting the performance of the ink-jet head 200, such as causing the jetting trajectory to be bent or causing the ink to overflow. As a result, the ink-jetting is unstable in printing, leading to problems of incorrect graphic locations, altered printing patterns, and clogged orifice of the ink-jet head 200.

Please refer to FIG. 3 again, for solving the above-mentioned problems of residual ink accumulating in the ink-jet head 200, in the structure of the ink-jet device 3 of the present invention, the ink-jet head 200 has dielectric layers 150, 155, coated on an inner surface and an outer surface thereof. The dielectric layers 150, 155, can be hydrophilic or hydrophobic by controlling the voltage applied thereto, thereby solving problems of the residual ink in the ink-jet head 200 as well as an overflow of ink.

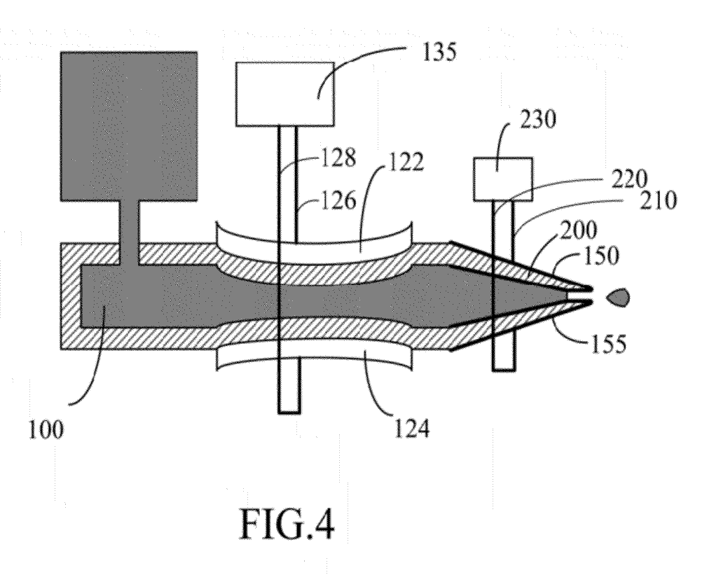

In the present embodiment, Teflon is used as a material for the dielectric layers 150, 155. However, the present invention is not limited thereto. The dielectric layers 150, 155 can be made of materials selected from a group consisting of propylene, PVDF (polyvinylidene fluoride), HFP (hexafluoropene), a methyl group, and an ethyl group. Please refer to FIGS. 3 and 4, which show the ink-jet device 3 of the present invention. The ink-jet head 200 has the dielectric layers 150, 155, coated on the inner surface and outer surface thereof. A pair of second electrodes 210, 220 have first ends thereof connected to a voltage generating unit 230 and second ends thereof connected to the dielectric layers 150, 155, respectively. When the voltage generating unit 230 does not apply voltages, the dielectric layers 150, 155, are hydrophobic. When the voltage generating unit 230 applies a voltage, the dielectric layers 150, 155, becomes hydrophilic. Hence, the present invention utilizes such a characteristic to overcome the problems of residual ink in the ink-jet head 200 and ink overflow. It is noted that the present invention is not limited to using the voltage generating unit 230. Any method that is capable of applying a voltage to the dielectric layers 150, 155 is applicable for the present invention.

Please refer to FIG. 3, which shows the ink-jet device 3 of the present invention. In a condition where hydrophobic ink is used, before jetting ink, no voltages are applied to the pressure generating units 122, 124, and the dielectric layers 150, 155. At this time, the pressure generating units 122,124 are not deformed and the ink-jet head 200 does not jet any ink. Furthermore, the dielectric layers 150, 155, maintain to be hydrophobic. The ink and the dielectric layers 150, 155, are both hydrophobic. Since the materials with the similar property contact each other, there is less mutual repulsion occurring. As a result, the ink is able to be distributed evenly in the spaces of the ink chamber 100 and the ink-jet head 200, and bubbles are not easily generated.

As shown in FIG. 4, when the ink-jet device 3 is in a state of ink-jetting, the pulse generator 135 applies a voltage to the pressure generating units 122,124 through the first electrodes 126, 128 and at the same time the voltage generating unit 230 applies a voltage to the dielectric layers 150, 155 through the second electrodes 210, 220. The pressure generating units 122, 124, are transformed to compress the ink chamber 100 to jet the ink. In the meantime, the dielectric layers 150, 155, are altered from hydrophobic into hydrophilic since the voltage generating unit 230 applies the voltage thereto via the second electrodes 210, 220. At this time, the ink is hydrophobic while the dielectric layers 150, 155, are hydrophilic, the materials with different properties contact each other, resulting in mutual repulsion due to the effect of cohesion. Therefore, the ink is more easily jetted out from the ink-jet head 200 and the residual ink is hardly accumulated in the ink-jet head 200 because of the difference between hydrophilic and hydrophobic properties.

Please refer to the ink-jet device 3 shown in FIG. 3 again. When hydrophilic ink is used, before jetting ink, no voltage is applied to the pressure generating units 122, 124, only the dielectric layers 150, 155, are applied with the voltage. At this time, the pressure generating units 122, 124, are not deformed and the ink-jet head 200 does not jet any ink, while the dielectric layers 150, 155, are altered from hydrophobic into hydrophilic due to the voltage applied from the voltage generating unit 230. The ink and the dielectric layers 150, 155, are both hydrophilic. As materials with the similar property contact each other, mutual repulsion is not easy to occur. Therefore, the ink is able to be distributed evenly in the spaces of the ink reservoir 100 and the ink-jet head 200 so that bubbles are not easily generated.

Again, as shown in FIG. 4, when the ink-jet device 3 is at a state of ink-jetting, the pulse generator 135 applies a voltage to the pressure generating units 122, 124, so the pressure generating units 122, 124, are deformed to compress the ink chamber 100 and the hydrophilic ink is jetted out from the ink-jet head 200. At the same time, the voltage provided from the voltage generating unit 230 is removed away from the dielectric layers 150, 155, so that the dielectric layers 150, 155 are changed from hydrophilic into hydrophobic. The hydrophilic ink and the hydrophobic dielectric layers 150, 155, with different properties contact each other, and are mutually repulsed due to cohesion. Accordingly, the ink is easily jetted out from the ink-jet head 200 and the ink is not easily accumulated in the ink-jet head 200 as a residue due to the difference between hydrophobic and hydrophilic properties.

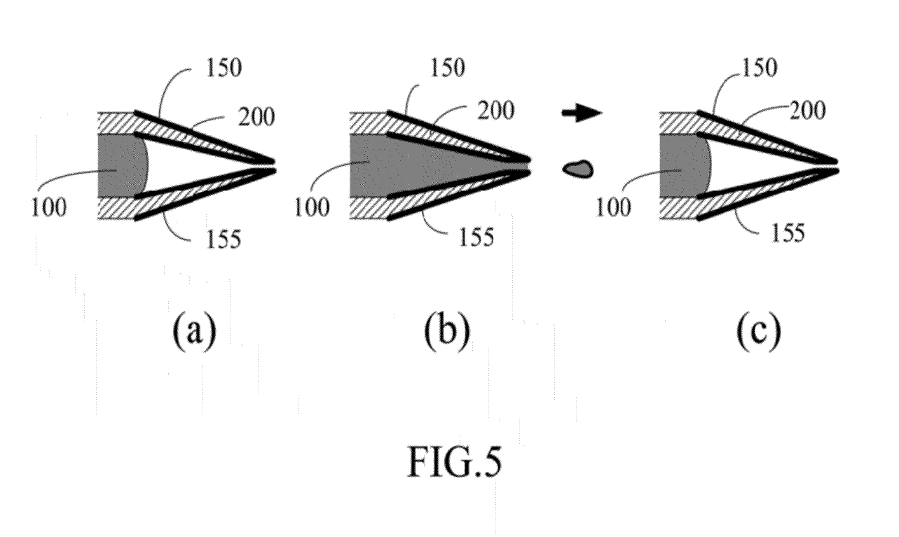

As shown in FIGS. 5(a) to 5(c), which show the conditions of the ink-jet device of the present invention before, during and after jetting ink. As shown in FIG. 5(a), before jetting ink, the ink is restrained in the ink chamber 100 due to the effect of cohesion. There is no residual ink accumulated in the ink-jet head 200. FIG. 5(b) shows the ink-jet device is during the process of jetting ink, the ink is jetted out from the ink chamber 100 to a target object (not shown) through the ink-jet head 200. As shown in FIG. 5(c), after jetting ink, the ink is restrained in the ink chamber 100 again due to the effect of cohesion, and there is no residual ink accumulated in the ink-jet head 200.

Another advantage for the present invention is that the dielectric layers 150, 155 of the ink-jet head 200 can be changed to be hydrophobic or hydrophilic by controlling whether the voltage is applied thereto or not, so as to operate in coordination with hydrophilic ink or hydrophobic ink. Therefore, the same ink-jet head 200 is applicable for two different kinds of inks. It is more convenient for a user since he or she does not need to buy two different ink cartridges.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An ink-jet device, comprising:
an ink chamber for temporarily storing ink used in an ink-jetting process;
an ink reservoir for supplying the ink to the ink chamber;
pressure generating units attached on an outer wall of the ink chamber, for compressing the ink chamber to deliver forward the ink from the ink chamber when the pressure generating units are transformed; and
an ink-jet head for narrowing an outflow channel, jetting out the ink from the ink chamber onto a target object, the ink-jet head having dielectric layers coated on an inner surface and an outer surface thereof;
wherein the dielectric layers are controlled to be hydrophilic or hydrophobic by controlling whether a voltage is applied thereto.

2. The ink-jet device according to claim 1, wherein the pressure generating units are coupled to a pulse generator through a pair of first electrodes, and the pulse generator applies a voltage to the pressure generating units to cause the pressure generating units compress the ink chamber for jetting out the ink stored in the ink chamber onto the target object through the ink-jet head.

3. The ink-jet device according to claim 1, wherein each of the pressure generating units comprises a piezoelectric element or a thermal bubble actuator.

4. The ink-jet device according to claim 1, wherein the dielectric layers are coupled to a voltage generating unit through a pair of second electrodes, and the voltage generating unit generates the voltage for controlling the dielectric layers to be hydrophobic or hydrophilic.

5. The ink-jet device according to claim 1, wherein the dielectric layers are made of materials selected from a group consisting of Teflon (PTFE, polytetrafluoroethylene), propylene, PVDF (polyvinylidene fluoride), HFP (hexafluoropene) a methyl group, and an ethyl group.

6. The ink-jet device according to claim 1, wherein the ink is either hydrophobic or hydrophilic.

7. An ink-jet head for narrowing an outflow channel jetting out ink onto a target object, the ink-jet head comprising:
dielectric layers coated on an inner surface and an outer surface of the ink-jet head;
wherein the dielectric layers are controlled to be hydrophilic or hydrophobic by controlling a voltage applied thereto.

8. The ink-jet head according to claim 7, wherein the dielectric layers are coupled to a voltage generating unit through a pair of electrodes, and the voltage generating unit generates the voltage to change the dielectric layers to be hydrophobic or hydrophilic, so that the dielectric layers operate in coordination with the ink which is hydrophilic or hydrophobic to make the ink-jet head jet-out the ink onto the target object.

9. The ink-jet head according to claim 8, wherein the dielectric layers are made of materials selected from a group consisting of Teflon (PTFE, polytetrafluoroethylene), propylene, PVDF (polyvinylidene fluoride), HFP (hexafluoropene) a methyl, and an ethyl.
